(19) United States
(12) Patent Application Publication
(10) Pub. No.: US 2017/0286434 A1
(43) Pub. Date: Oct. 5, 2017

(54) SYSTEM AND METHOD FOR SIGNATURE-BASED CLUSTERING OF MULTIMEDIA CONTENT ELEMENTS

(71) Applicant: Cortica, Ltd., Tel Aviv (IL)

(72) Inventors: Igal RAICHELGAUZ, Tel Aviv (IL); Karina ODINAEV, Tel Aviv (IL); Yehoshua Y. ZEEVI, Haifa (IL)

(73) Assignee: Cortica, Ltd., TEL AVIV (IL)

(21) Appl. No.: 15/628,178

(22) Filed: Jun. 20, 2017

Related U.S. Application Data
(63) Continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/352,565, filed on Jun. 21, 2016.

(30) Foreign Application Priority Data
Oct. 26, 2005 (IL) 171577
Jan. 26, 2006 (IL) 173409
Aug. 21, 2007 (IL) 185414

(51) Int. Cl. G06F 17/30; H04H 60/46; H04H 60/66; H04N 7/173; H04N 21/258; H04N 21/2668; H04N 21/466; H04N 21/81; H04H 20/26; H04H 60/37; H04H 60/56; H04H 20/10; H04L 29/08

(52) U.S. Cl. CPC G06F 17/30056; H04H 20/103; H04H 60/46; H04H 60/66; H04N 7/17318; H04N 21/25891; H04N 21/2668; H04L 67/10; H04N 21/8106; H04H 20/26; H04H 60/37; H04H 60/56; H04N 21/466

(57) ABSTRACT

A system and method for signature-based clustering of multimedia content elements. The method includes generating at least one signature for a first multimedia content element; determining, based on the generated at least one signature, at least one tag for the first multimedia content element; searching, using the determined at least one tag, for at least one matching multimedia content element cluster in at least one data source, wherein each multimedia content element cluster includes a plurality of clustered multimedia content elements sharing a common concept; and adding the first multimedia content element to each matching multimedia content element cluster.

### CROSS-REFERENCE TO RELATED APPLICATIONS

This application claims the benefit of U.S. Provisional Application No. 62/352,565 filed on Jun. 21, 2016. This application is also a continuation-in-part of U.S. patent application Ser. No. 13/770,603 filed on Feb. 19, 2013, now pending, which is a continuation-in-part (CIP) of U.S. patent application Ser. No. 13/624,397 filed on Sep. 21, 2012, now U.S. Pat. No. 9,191,626. The Ser. No. 13/624,397 application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and

(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to clustering multimedia content elements, and more specifically to clustering multimedia content elements based on analysis of content in the multimedia content elements.

### BACKGROUND

As content available over the Internet continues to exponentially grow in size and content, the task of finding relevant content has become increasingly cumbersome. Further such content may not always be sufficiently organized or identified, thereby resulting in missed content.

In particular, some existing solutions for organizing content include grouping multimedia content elements into clusters related by common subject matter. In such solutions, the clusters of multimedia content elements may share a common tag or other metadata featuring a description of the content. In computer science, a tag is a non-hierarchical keyword or term assigned to a piece of information such as a multimedia content element.

However, metadata is often not sufficiently descriptive of the multimedia content element. As a result, grouping multimedia content elements based on metadata may not result in accurate organization of the content. Further, any clusters created based on this grouping may not include all appropriate multimedia content elements. For example, a person may tag a picture of a cat with the tag “weekend fun.” The image of the cat does not have metadata indicating the cat and, therefore, would not be grouped with other images showing cats that are properly tagged and, therefore, would be excluded from a cluster of cat images.

It would be therefore advantageous to provide a solution for accurately recommending tags that matches the multimedia content elements.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for signature-based clustering of multimedia content elements. The method comprises: generating at least one signature for a first multimedia content element; determining, based on the generated at least one signature, at least one tag for the first multimedia content element; searching, using the determined at least one tag, for at least one matching multimedia content element cluster in at least one data source, wherein each multimedia content element cluster includes a plurality of clustered multimedia content elements sharing a common concept; and adding the first multimedia content element to each matching multimedia content element cluster.

Certain embodiments disclosed herein also include a non-transitory computer readable medium having stored thereon causing a processing circuitry to execute a process, the process comprising: generating at least one signature for a first multimedia content element; determining, based on the generated at least one signature, at least one tag for the first multimedia content element; searching, using the determined at least one tag, for at least one matching multimedia content element cluster in at least one data source, wherein each multimedia content element cluster includes a plurality of clustered multimedia content elements sharing a common concept; and adding the first multimedia content element to each matching multimedia content element cluster.

Certain embodiments disclosed herein also include a system for signature-based clustering of multimedia content elements. The system comprises: a processing circuitry; and a memory, the memory containing instructions that, when executed by the processing circuitry, configure the processing circuitry to: generate at least one signature for a first multimedia content element; determine, based on the generated at least one signature, at least one tag for the first multimedia content element; search, using the determined at least one tag, for at least one matching multimedia content element cluster in at least one data source, wherein each multimedia content element cluster includes a plurality of clustered multimedia content elements sharing a common concept; and add the first multimedia content element to each matching multimedia content element cluster.

### BRIEF DESCRIPTION OF THE DRAWINGS

The subject matter that is regarded as the disclosure is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments herein.

FIG. 2 is a schematic diagram of a multimedia content element clusterer according to an embodiment.

FIG. 3 is a flowchart illustrating a method for signature-based clustering of multimedia content elements according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

A system and method for signature-based clustering of multimedia content elements. Signatures are generated for a multimedia content element to be clustered. Based on the generated signatures, at least one tag is determined for the multimedia content element. The multimedia content element is added to a multimedia content element cluster based on the at least one tag. A visual representation of the multimedia content element cluster including the added multimedia content element may be generated and displayed on a user device.

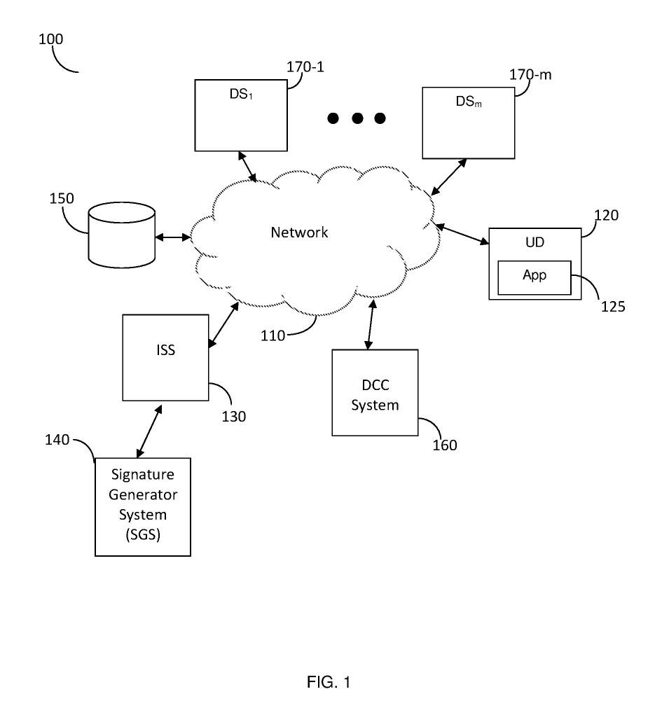

FIG. 1 is an example network diagram 100 utilized to describe the various disclosed embodiments. The network diagram 100 includes a user device 120, a multimedia content element (MMCE) clusterer 130, a database 150, a deep content classification (DCC) system 160, and a plurality of data sources 170-1 through 170-m (hereinafter referred to individually as a data source 170 and collectively as data sources 170, merely for simplicity purposes) communicatively connected via a network 110. The network 110 may be, but is not limited to, the Internet, the world-wide-web (WWW), a local area network (LAN), a wide area network (WAN), a metro area network (MAN), and other networks capable of enabling communication between the elements of the network diagram 100.

The user device 120 may be, but is not limited to, a personal computer (PC), a personal digital assistant (PDA), a mobile phone, a smart phone, a tablet computer, a wearable computing device and other kinds of wired and mobile appliances, equipped with image capturing, browsing, viewing, listening, filtering, managing, and other capabilities that are enabled as further discussed herein below. The user device 120 may have installed thereon an application 125 such as, but not limited to, a web browser. The application 125 may be configured to store multimedia content elements in, for example, the data sources 170, to send multimedia content elements to the MMCE clusterer 130, or both. For example, the application 125 may be a web browser through which a user of the user device 120 accesses a social media website and uploads multimedia content elements when one of the data sources 170 is associated with the social media website.

The database 150 may be a tag database storing information such as, but not limited to, reference multimedia content elements, reference signatures, predetermined tags, and the like.

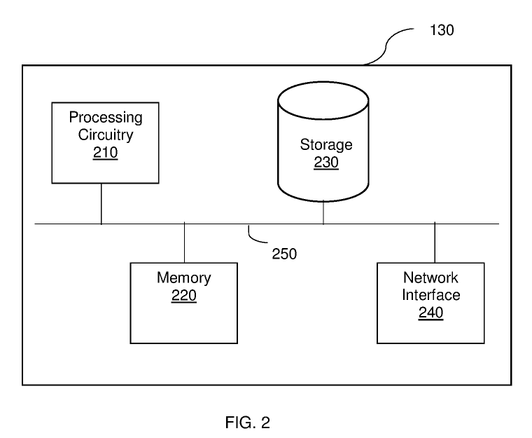

In an embodiment, the MMCE clusterer 130 includes a processing circuitry coupled to a memory (e.g., the processing circuitry 210 and the memory 220 as shown in FIG. 2). The memory contains instructions that can be executed by the processing circuitry. In a further embodiment the MMCE clusterer 130 may include an array of at least partially statistically independent computational cores configured as described in more detail herein below.

In an embodiment, the MMCE clusterer 130 is communicatively connected to a signature generator system (SGS) 140, which is utilized by the MMCE clusterer 130 to perform the various disclosed embodiments. Specifically, the signature generator system 140 is configured to generate signatures to multimedia content elements and includes a plurality of computational cores, each computational core having properties that are at least partially statistically independent of each other core, where the properties of each core are set independently of the properties of each other core.

The signature generator system 140 may be communicatively connected to the MMCE clusterer 130 directly (as shown), or through the network 110 (not shown). In another embodiment, the MMCE clusterer 130 may further include the signature generator system 140, thereby allowing the MMCE clusterer 130 to generate signatures for multimedia content elements.

In an embodiment, the MMCE clusterer 130 is communicatively connected to the deep content classification system 160, which is utilized by the MMCE clusterer 130 to perform the various disclosed embodiments. Specifically, the deep content classification system 160 is configured to create, automatically and in an unsupervised fashion, concepts for a wide variety of multimedia content elements. To this end, the deep content classification system 160 may be configured to inter-match patterns between signatures for a plurality of multimedia content elements and to cluster the signatures based on the inter-matching. The deep content classification system 160 may be further configured to reduce the number of signatures in a cluster to a minimum that maintains matching and enables generalization to new multimedia content elements. Metadata of the multimedia content elements is collected to form, together with the reduced clusters, a concept. An example deep content classification system is described further in U.S. Pat. No. 8,266,185, assigned to the common assignee, the contents of which are hereby incorporated by reference.

The deep content classification system 160 may be communicatively connected to the MMCE clusterer 130 directly (not shown), or through the network 110 (as shown). In another embodiment, the MMCE clusterer 130 may further include the deep content classification system 160, thereby allowing the MMCE clusterer 130 to create a concept database and to match concepts from the concept database to multimedia content elements.

In an embodiment, the MMCE clusterer 130 is configured to receive, from the user device 120, a multimedia content element to be clustered. Alternatively, the MMCE clusterer 130 is configured to receive, from the user device 120, an indicator of a location of the multimedia content element to be clustered in storage (e.g., in one of the data sources 170). When an indicator of a location in storage is received, the MMCE clusterer 130 is configured to retrieve the multimedia content element based on the indicator. The multimedia content element may be, but is not limited to, an image, a graphic, a video stream, a video clip, an audio stream, an audio clip, a video frame, a photograph, an image of signals (e.g., spectrograms, phasograms, scalograms, etc.), combinations thereof, portions thereof, and the like.

In an embodiment, the MMCE clusterer 130 is configured to send the multimedia content element to be clustered to the signature generator system 140, to the deep content classification system 160, or both. The MMCE clusterer 130 is configured to receive signatures generated to the image from the signature generator system 140, to receive a signature (e.g., a signature reduced cluster) of a concept matched to the image from the deep content classification system 160, or both. In another embodiment, the MMCE clusterer 130 may be configured to generate the signatures, to identify the signatures (e.g., by determining concepts associated with the signature reduced clusters matching the image to be shared), or a combination thereof.

Each signature represents a concept, and may be robust to noise and distortion. Each concept is a collection of signatures representing multimedia content elements and metadata describing the concept, and acts as an abstract description of the content to which the signature was generated. As a non-limiting example, a ‘Superman concept’ is a signature-reduced cluster of signatures describing elements (such as multimedia elements) related to, e.g., a Superman cartoon: a set of metadata representing proving textual representation of the Superman concept. As another example, metadata of a concept represented by the signature generated for a picture showing a bouquet of red roses is “flowers”. As yet another example, metadata of a concept represented by the signature generated for a picture showing a bouquet of wilted roses is “wilted flowers”.

It should be noted that using signatures for tagging the multimedia content element to be clustered ensures more accurate tagging than, for example, based on manually added metadata alone. Specifically, the signatures, as described herein, allow for recognition and classification of multimedia content elements.

In an embodiment, based on the signatures of the multimedia content element to be clustered, the MMCE clusterer 130 is configured to determine at least one tag for the multimedia content element. To this end, the MMCE clusterer 130 may be configured to compare the generated signatures to a plurality of reference signatures associated with predetermined tags to determine at least one tag for the multimedia content element. Each of the reference signatures is generated to a reference multimedia content element featuring content related to the tag. As a non-limiting example, a reference signature may be previously generated to an image of a dog fetching a ball associated with the tags “dog,” “ball,” and “fetch.” In another implementation, the concept matching the multimedia content element may be compared to a plurality of concepts associated with predetermined tags to determine at least one tag for the multimedia content element to be clustered. The reference signatures or concepts and associated predetermined tags may be stored in, e.g., the database 150.

Each tag is searchable metadata for a multimedia content element indicating content of the multimedia content element. As a non-limiting example, tags for a video showing a person and a dog may include a name of the person, “me,” “dog,” and “my dog and I.” In some implementations, the determination of the tags may also be based on metadata associated with the multimedia content element. To this end, the generated signatures may further include signatures generated for the metadata of the multimedia content element to be clustered. As a non-limiting example, when metadata of an image indicates that the image was captured via a user-side camera and the image includes a picture of a person's face, a reference signature generated for a reference image associated with the tag “selfie” may be found, and the determined tags include the tag “selfie.” A selfie is a self-portrait photograph taken by a user of a user device. The selfie shows the user, and is typically captured via a camera located on the screen side of the user device.

In an embodiment, based on the determined tags, the MMCE clusterer 130 is configured to search through the user device 120, one or more of the data sources 170, or both, for at least one matching multimedia content element (MMCE) cluster. To this end, the MMCE clusterer 130 may be configured to query the user device 120 or the data source 170 using the determined tags in order to find a matching MMCE cluster for the tag. A MMCE cluster may match a tag if, e.g., metadata associated with the MMCE cluster matches the tag above a predetermined threshold.

Each MMCE cluster includes a plurality of multimedia content elements featuring a common concept. The common concept may be, but is not limited to, an object featured in the multimedia content element (e.g., a person, an animal, a building, a particular object such as a person having a particular name, etc.), a meta aspect of the multimedia content element (e.g., an indication that the multimedia content element is a selfie, a location where the multimedia content element was captured, a group associated with members featured in the multimedia content element, etc.), and the like. Each common concept is represented by at least a portion of a signature that is common among multimedia content elements of the MMCE cluster. Metadata of a MMCE cluster includes at least the metadata of the common concept of the cluster. As a non-limiting example, metadata for a MMCE cluster of images showing family members of the Smith family may indicate the common concept “Smith family photographs.” As another example, metadata for a MMCE cluster of videos featuring cats may indicate the common concept “cats.”

It should be noted that searching for matching MMCE clusters based on tags for an input multimedia content element allows for searching in data sources for previously created MMCE clusters without requiring generation of signatures for each searched MMCE cluster, thereby conserving computing resources as compared to, e.g., comparing the signatures generated for the input multimedia content element to signatures representing each of the MMCE clusters. Further, as noted above, the tags are determined for the input multimedia content element based on signatures, thereby resulting in accurate tagging and, consequently, clustering, of multimedia content elements (i.e., such that clusters are likely to include only multimedia content elements that are conceptually related).

In an embodiment, the MMCE clusterer 130 is configured to add the multimedia content element to each matching MMCE cluster. Adding the multimedia content element to matching MMCE clusters allows for grouping of multimedia content elements based on common content. As noted above, as the clustering is based on signatures generated for the multimedia content element as described herein, the clusters may be more accurate groupings than, for example, groupings created based on metadata of the multimedia content element alone.

In an embodiment, the MMCE clusterer 130 may be configured to select a representative multimedia element of a MMCE cluster. The representative multimedia content element is the multimedia content element that is likely to most accurately represent the common concept of the cluster. To this end, the representative multimedia content element may be a multimedia content element of the MMCE having a signature with the highest degree of matching as compared to a signature reduced cluster representing the common concept of the MMCE cluster. The signature reduced cluster for a MMCE cluster is a reduced cluster of signatures created based on signatures of multimedia content elements in the MMCE cluster that define common features of the clustered multimedia content elements. As a non-limiting example, a signature reduced cluster for the Smith family photographs MMCE cluster may include signatures representing each family member such that a representative multimedia content element for the MMCE cluster may be an image showing all 10 family members (e.g., as compared to other images showing only one or some of the family members).

If no matching MMCE cluster is found for one or more of the determined tags, the MMCE clusterer 130 may be configured to create a new MMCE cluster including the multimedia content element for each non-matching tag. The metadata for each new MMCE cluster includes the respective non-matching tag. As tags for additional multimedia content elements are determined, the additional multimedia content elements having tags matching the metadata of the new MMCE cluster may be added.

In an embodiment, the MMCE clusterer 130 may be configured to generate visual representations of the MMCE clusters and to send the generated visual representations for display on the user device 120. Each visual representation includes one or more of the multimedia content elements of an MMCE cluster, and may be generated based on the multimedia content elements and one or more visual representation generation rules. The visual representation rules may be defined by, e.g., a user of the user device 120, and define parameters for visually representing the multimedia content elements.

The visual representations may be further generated based on metadata of each visually represented multimedia content element. As a non-limiting example, an image extracted from a social media platform may be visually represented in a round frame, while an image extracted from the user device 120 may be visually represented in a square frame. Further, images extracted from different social media platforms may be visually represented by frames having different colors, shapes, or both.

In an embodiment, the MMCE clusterer 130 may be configured to generate a recommendation for a name of each MMCE cluster. The generated recommendation may be based on the metadata of the MMCE cluster. In an example implementation, the recommended name for a MMCE cluster may be displayed with the visual representation of the MMCE cluster on a display of the user device 120, thereby allowing a user of the user device 120 to confirm or modify the recommended name.

It should be noted that only one user device 120 and one application 125 are described herein above with reference to FIG. 1 merely for the sake of simplicity and without limitation on the disclosed embodiments. Multiple user devices may provide multimedia content elements via multiple applications 125, and tags for each multimedia content element may be recommended to the sending user device, without departing from the scope of the disclosure.

FIG. 2 is an example schematic diagram 200 of a multimedia content element (MMCE) clusterer 130 according to an embodiment. The MMCE clusterer 130 includes a processing circuitry 210 coupled to a memory 220, a storage 230, and a network interface 240. In an embodiment, the components of the MMCE clusterer 130 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 210 may be realized as an array of at least partially statistically independent computational cores. The properties of each computational core are set independently of those of each other core, as described further herein above.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, cause the processing circuitry 210 to perform the various processes described herein. Specifically, the instructions, when executed, cause the processing circuitry 210 to tag and cluster multimedia content elements as described herein.

The storage 230 may be magnetic storage, optical storage, and the like, and may be realized, for example, as flash memory or other memory technology, CD-ROM, Digital Versatile Disks (DVDs), or any other medium which can be used to store the desired information.

The network interface 240 allows the MMCE clusterer 130 to communicate with the signature generator system 140, the deep content classification system 160, or both, for the purpose of, for example, sending multimedia content elements, receiving signatures, and the like. Further, the network interface 240 allows the MMCE clusterer 130 to communicate with the user device 120 for the purpose of, for example, receiving images, sending visual representations for display, and the like.

It should be understood that the embodiments described herein are not limited to the specific architecture illustrated in FIG. 2, and other architectures may be equally used without departing from the scope of the disclosed embodiments. In particular, the MMCE clusterer 130 may further include a signature generator system configured to generate signatures as described herein without departing from the scope of the disclosed embodiments.

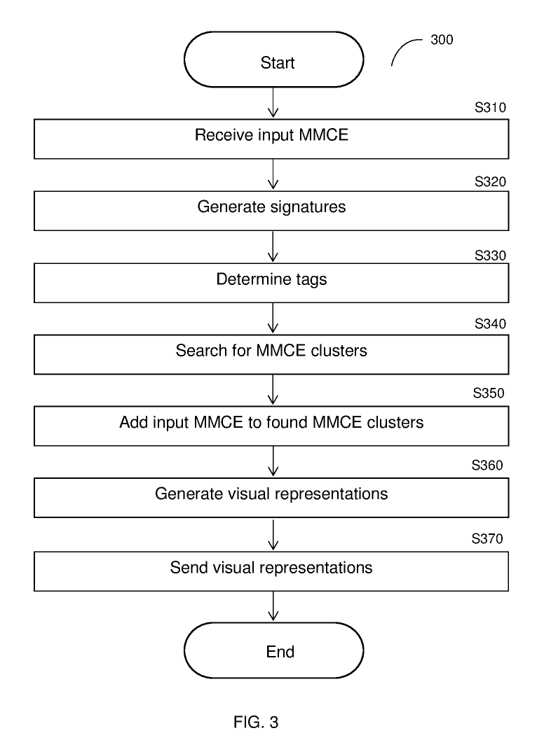

FIG. 3 depicts an example flowchart 300 illustrating a method for signature-based clustering multimedia content elements according to an embodiment. In an embodiment, the method is performed by the MMCE clusterer 130.

At S310, an input multimedia content element is received or retrieved. The multimedia content element or an indicator of the multimedia content element may be received from, e.g., a user device. The indicator may be, e.g., a pointer to a location in storage. When an indicator of the multimedia content element is received, the multimedia content element may be retrieved based on the indicator.

At S320, at least one signature is generated for the input multimedia content element. The signatures may be generated by a signature generator system or deep content classification system.

In an embodiment, S320 includes generating the signatures via a plurality of at least partially statistically independent computational cores, where the properties of each core are set independently of the properties of the other cores. In another embodiment, S320 includes sending the input multimedia content element to a signature generator system, to a deep content classification system, or both, and receiving the signatures. The signature generator system includes a plurality of at least statistically independent computational cores as described further herein. The deep content classification system is configured to create concepts for a wide variety of multimedia content elements, automatically and in an unsupervised fashion. To this end, S320 may include receiving a signature representing a concept matching the input multimedia content element.

In another embodiment, the generated signatures may further include signatures generated for metadata of the input image. The metadata may indicate, for example, a location of capture of the input multimedia content element, a sensor from which the input multimedia content element was captured, a user of the device that captured the input multimedia content element, a time of capture of the input multimedia content element, and the like.

At S330, based on the generated signatures, at least one tag is determined for the input multimedia content element. In an embodiment, S330 includes comparing the generated signatures to reference signatures of reference multimedia content elements associated with predetermined tags. Each predetermined tag is a non-hierarchical keyword or term indicating a concept of the respective reference multimedia content element.

At S340, based on the determined tags, a search is performed to find at least one matching multimedia content element (MMCE) cluster. In an embodiment, S340 includes querying one or more data sources using the tags. The queried data sources may include, but are not limited to, user devices, servers (e.g., servers of social media platforms), and other data sources storing MMCE clusters.

At S350, the input multimedia content element is added to each matching MMCE cluster. The matching MMCE clusters with the added input multimedia content element may be sent for storage in, e.g., the data source in which each matching MMCE cluster was found. In an embodiment, if no matching MMCE cluster is found, S350 may include creating a MMCE cluster including the input multimedia content element.

At S360, a visual representation may be generated for each MMCE cluster. The visual representation for each MMCE cluster includes at least a portion of one or more images or other visual multimedia content elements of the MMCE cluster. The visual representation of each MMCE cluster may be generated based on the multimedia content elements of the MMCE cluster and visual representation generation rules. The visual representation of a MMCE cluster may be further generated based on metadata of each multimedia content element of the MMCE cluster. For example, a color, shape, size, or other feature of the multimedia content element or a frame surrounding the multimedia content element may differ for, e.g., multimedia content elements extracted from different data sources (e.g., a user device, a social media server, etc.), multimedia content elements captured from different devices or sensors, multimedia content elements captured at different locations, multimedia content elements captured during different periods of time, and the like.

At S370, the generated visual representations may be sent for, e.g., storage or display on, for example, a user device (e.g., the user device 120). Any of the sent visual representations may be displayed in sequence or in parallel.

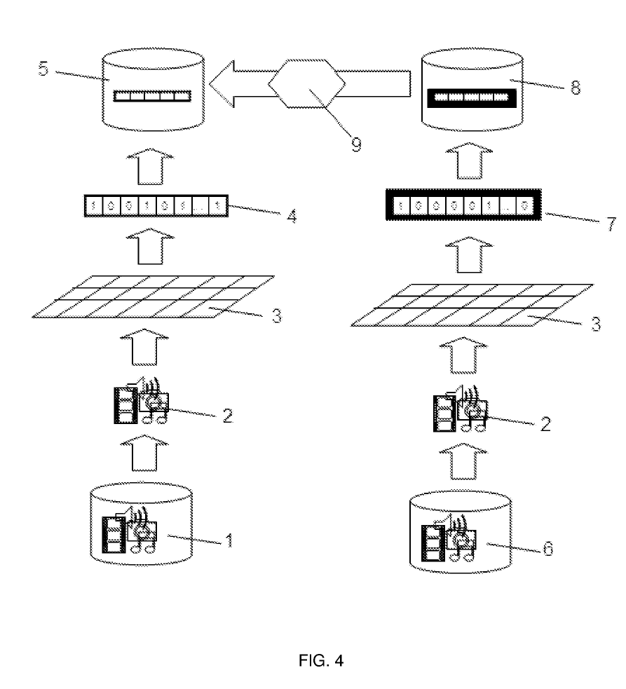

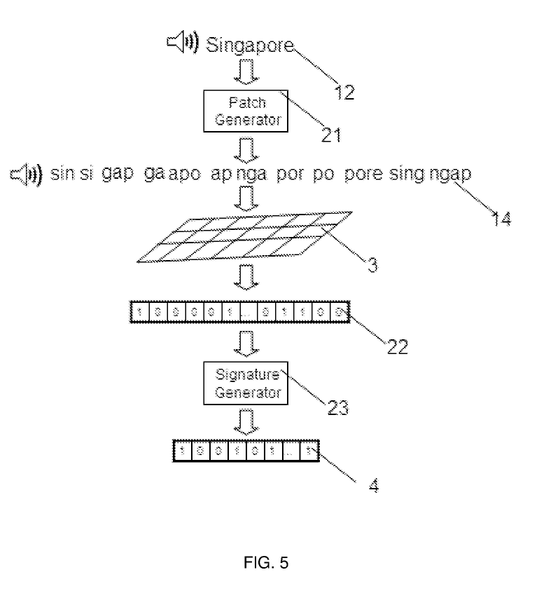

FIGS. 4 and 5 illustrate the generation of signatures for the multimedia content elements by the SGS 140 according to an embodiment. An exemplary high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment the server 130 is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ}(1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:
1: For: Vᵢ>Th_{RS}
   1−p(V>Th_{S})−1−(1−ε)^{l}<<1
      i.e., given that l nodes (cores) constitute a Robust Signature of a certain image I, the probability that not all of these I nodes will belong to the Signature of same, but noisy image, Ĩ is sufficiently low (according to a system's specified accuracy).
2: p(Vᵢ>Th_{RS})≈I/L
   i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in U.S. Pat. No. 8,655,801 referenced above.

It should be noted that various embodiments described herein are discussed with respect to sharing an image merely for simplicity purposes and without limitation on the disclosed embodiments. Other types of multimedia content elements and, in particular, visual multimedia content elements such as videos, may be analyzed and shared with people featured therein, without departing from the scope of the disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for clustering multimedia content elements, comprising:
generating at least one signature for a first multimedia content element;
determining, based on the generated at least one signature, at least one tag for the first multimedia content element;
searching, using the determined at least one tag, for at least one matching multimedia content element cluster in at least one data source, wherein each multimedia content element cluster includes a plurality of clustered multimedia content elements sharing a common concept; and
adding the first multimedia content element to each matching multimedia content element cluster.

2. The method of claim 1, further comprising:
generating a visual representation of each matching multimedia content element cluster including the added first multimedia content element, wherein each generated visual representation includes at least one of the multimedia content elements of the multimedia content element cluster; and
sending, to a user device, at least one of the at least one visual representation for display.

3. The method of claim 2, wherein each visual representation is generated based further on metadata of the multimedia content elements of the respective multimedia content element cluster.

4. The method of claim 1, further comprising:
for each matching multimedia content element cluster including the added first multimedia content element:
comparing at least one signature generated for each multimedia content element of the multimedia content element cluster to a signature reduced cluster of the multimedia content element cluster; and
selecting, based on the comparison, a representative multimedia content element of the multimedia content element cluster.

5. The method of claim 1, further comprising:
generating, based on metadata of each matching multimedia content element cluster, a recommendation of a name for the multimedia content element cluster.

6. The method of claim 1, wherein each signature represents a concept, wherein each concept is a collection of signatures and metadata representing the concept.

7. The method of claim 1, wherein each signature is generated by a signature generator system, wherein the signature generator system includes a plurality of at least statistically independent computational cores, wherein the properties of each core are set independently of the properties of each other core.

8. The method of claim 7, wherein generating the at least one signature further comprises:
sending the image to the signature generator system; and
receiving, from the signature generator system, the at least one signature.

9. The method of claim 1, wherein determining the at least one tag for the first multimedia content element further comprises:
comparing the generated at least one signature to a plurality of reference signatures, wherein each reference signature is associated with at least one predetermined tag, wherein each tag determined for the first multimedia content element is one of the predetermined tags associated with a reference signature matching at least a portion of the generated at least one signature above a predetermined threshold.

10. A non-transitory computer readable medium having stored thereon instructions for causing a processing circuitry to execute a process, the process comprising:
generating at least one signature for a first multimedia content element;
determining, based on the generated at least one signature, at least one tag for the first multimedia content element;
searching, using the determined at least one tag, for at least one matching multimedia content element cluster in at least one data source, wherein each multimedia content element cluster includes a plurality of clustered multimedia content elements sharing a common concept; and
adding the first multimedia content element to each matching multimedia content element cluster.

11. A system for sharing an image showing at least one person, comprising:
a processing circuitry; and
a memory connected to the processing circuitry, the memory containing instructions that, when executed by the processing circuitry, configure the system to:
generate at least one signature for a first multimedia content element;
determine, based on the generated at least one signature, at least one tag for the first multimedia content element;
search, using the determined at least one tag, for at least one matching multimedia content element cluster in at least one data source, wherein each multimedia content element cluster includes a plurality of clustered multimedia content elements sharing a common concept; and
add the first multimedia content element to each matching multimedia content element cluster.

12. The system of claim 11, wherein the system is further configured to:
generate a visual representation of each matching multimedia content element cluster including the added first multimedia content element, wherein each generated visual representation includes at least one of the multimedia content elements of the multimedia content element cluster; and
send, to a user device, at least one of the at least one visual representation for display.

13. The system of claim 12, wherein each visual representation is generated based further on metadata of the multimedia content elements of the respective multimedia content element cluster.

14. The system of claim 11, wherein the system is further configured to:
for each matching multimedia content element cluster including the added first multimedia content element:
compare at least one signature generated for each multimedia content element of the multimedia content element cluster to a signature reduced cluster of the multimedia content element cluster; and
select, based on the comparison, a representative multimedia content element of the multimedia content element cluster.

15. The system of claim 11, wherein the system is further configured to:
generate, based on metadata of each matching multimedia content element cluster, a recommendation of a name for the multimedia content element cluster.

16. The system of claim 11, wherein each signature represents a concept, wherein each concept is a collection of signatures and metadata representing the concept.

17. The system of claim 11, wherein the system is further configured to:
a signature generator system, wherein each signature is generated by the signature generator system, wherein the signature generator system includes a plurality of at least statistically independent computational cores, wherein the properties of each core are set independently of the properties of each other core.

18. The system of claim 11, wherein the system is further configured to:
send the image to a signature generator system, wherein the signature generator system includes a plurality of at least statistically independent computational cores, wherein the properties of each core are set independently of the properties of each other core; and
receive, from the signature generator system, the at least one signature.

19. The system of claim 11, wherein the system is further configured to:
compare the generated at least one signature to a plurality of reference signatures, wherein each reference signature is associated with at least one predetermined tag, wherein each tag determined for the first multimedia content element is one of the predetermined tags associated with a reference signature matching at least a portion of the generated at least one signature above a predetermined threshold.
